(19) United States
(12) Patent Application Publication
(10) Pub. No.: US 2024/0381218 A1
(43) Pub. Date: Nov. 14, 2024

(54) OPPORTUNISTIC DE-ENERGIZING OF EXCESS NETWORK REDUNDANCY

(71) Applicant: Cisco Technology, Inc., San Jose, CA (US)

(72) Inventors: Eric A. Voit, Bethesda, MD (US); Pascal Thubert, Roquefort les Pins (FR); Carlos Pignataro, Cary, NC (US)

(21) Appl. No.: 18/313,672

(22) Filed: May 8, 2023

(51) Int. Cl. H04W 40/08; H04W 28/02

(52) U.S. Cl. CPC H04W 40/08; H04W 28/0268

(57) ABSTRACT

Methods are provided for selectively depowering any device(s) that seem unnecessarily redundant to strike a balance between resiliency and sustainability to reduce energy costs. The analysis may include a current application mix in use on network paths. For example, a policy may require that at least two available paths are actively energized when real-time collaboration apps are running. Examples of a real-time collaboration app may be data mining in an online database stored elsewhere in the network or holding a video conference call. This double path redundancy can deliver increased application availability. And, in instances where just web/email are actively running, then a backup path that may be energized in less than a second, if a primary path loses connectivity. This lower-power method can also provide increased application availability.

### FIELD

The present disclosure relates to network routing. More particularly, the present disclosure relates to reducing excess power consumption in existing networks while maintaining acceptable performance.

### BACKGROUND

Keeping too many redundant networking paths in use may drive higher energy costs with minimal availability benefits. This may include the energization of frequencies, wires, and fibers on physically parallel networks (e.g., multiple Wi-Fi networks, SSIDs, 5G, and/or Bluetooth). Thus, it may be important to determine the balance between resiliency, sustainability, and when to power up alternative network paths to keep energy costs and Green House Gas (GHG) emissions low.

Some application Service-Level Agreements (SLAs) can easily handle transient outages. For example, web browsing needs from an enterprise location may be unlikely to care whether network outages for failover of one second are seen. Similarly, a 3G (third-generation cellular) network can take up to two seconds and require tens of control messages between the 3G device and the Radio Resource Control (RRC). This may be unacceptable latency for a restoral SLA, whereas a 5G (fifth-generation cellular) radio might only take sub-hundred milliseconds to transition from idle to connected states. As such, depowered connectivity might be valid to consider when determining the facilities which might compose an “available” redundancy path that takes little power.

### SUMMARY

Systems and methods for reducing excess power consumption in existing networks while maintaining acceptable performance in accordance with embodiments of the disclosure are described herein. In some embodiments, the disclosure described herein relates to a device, including a processor, at least one network interface controller configured to provide access to a network, and a memory communicatively coupled to the processor, wherein the memory includes a network path optimization logic. The network path optimization logic can be configured to identify network path options between two devices within the network, wherein the network includes a plurality of transport subsystems. The logic may further determine an availability profile for each network path option and also determine a power expenditure metric for each of the plurality of transport subsystems. Subsequently, the logic can generate a sustainable network path score based on the availability profile and the power expenditure metric before selecting a network path based on the generated sustainable network path score. Finally, the logic can power off the selected network path.

In some embodiments, the disclosure described herein relates to a device, wherein the network path options are identified within a set of devices.

In some embodiments, the disclosure described herein relates to a device, wherein the set of devices is within a managed network domain.

In some embodiments, the disclosure described herein relates to a device, wherein the device is in communication with a plurality of client applications.

In some embodiments, the disclosure described herein relates to a device, wherein the plurality of client applications has an associated service level agreement (SLA).

In some embodiments, the disclosure described herein relates to a device, wherein the availability profile is determined based on the client application SLAs.

In some embodiments, the disclosure described herein relates to a device, wherein the availability profile is determined based on the SLA with the highest level of availability.

In some embodiments, the disclosure described herein relates to a device, wherein the power expenditure metric is determined based on an expected bandwidth usage.

In some embodiments, the disclosure described herein relates to a device, wherein the power expenditure metric is determined based on all available bandwidth including currently powered down transport subsystems.

In some embodiments, the disclosure described herein relates to a device, wherein the network includes a plurality of point-to-point paths.

In some embodiments, the disclosure described herein relates to a device wherein the sustainable network path scores are generated for each of the plurality of point-to-point paths.

In some embodiments, the disclosure described herein relates to a device, wherein the generated sustainable network path scores for each point-to-point path are stored upon generation.

In some embodiments, the disclosure described herein relates to a device, wherein the network path optimization logic can be configured to generate a new sustainable network path score in response to a predefined event.

In some embodiments, the disclosure described herein relates to a device, wherein the predefined event is detecting a change in the identified network path options.

In some embodiments, the disclosure described herein relates to a device, wherein the predefined event is a network failure detection.

In some embodiments, the disclosure described herein relates to a device, wherein the predefined event is a service level agreement (SLA) change detection.

In some embodiments, the disclosure described herein relates to a method of reducing redundant network paths, including identifying network path options between two devices within a network, wherein the network includes a plurality of transport subsystems. The method can further include determining an availability profile for each network path option, along with determining a power expenditure metric for each of the plurality of transport subsystems. The method can also be configured for generating a sustainable network path score based on the availability profile and power expenditure metric prior to selecting a network path based on the generated sustainable network path score. Ultimately, the method can include powering off the selected network path.

In some embodiments, the disclosure described herein relates to a method, wherein powering off of a selected network path does not violate a service level agreement (SLA).

In some embodiments, the disclosure described herein relates to a method, wherein the method further powers on a selected network path based on the generated sustainable network path score to avoid a violation of a service level agreement (SLA).

In some embodiments, the disclosure described herein relates to a device, including a processor, at least one network interface controller (NIC), wherein the NIC provides access to a plurality of client devices within a network, and a memory communicatively coupled to the processor. The memory includes a network path optimization logic that is configured to establish a connection with one or more client applications associated with the plurality of client devices, wherein the one or more client applications are each associated with a service level agreement (SLA). The network path optimization logic can also identify network path options between two devices within the network, wherein the network includes a plurality of transport subsystems and determine an availability profile for each network path option based on the SLAs. The network path optimization logic may also determine a power expenditure metric for each of the plurality of transport subsystems and generate a sustainable network path score based on the availability profile and power expenditure metric. Subsequently, the network path optimization logic can select a network path based on the generated sustainable network path score and then adjust the energy usage of the selected network path. In response to the network path optimization logic detecting a change in an associated SLA, it can determine a new availability profile based on the changed SLA and generate an updated sustainable network path score based on the new availability profile before selecting an updated network path based on the updated sustainable network path score. Finally, the network path optimization logic can re-adjust the energy usage of the selected network path.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above and other aspects, features, and advantages of several embodiments of the present disclosure will be more apparent from the following description as presented in conjunction with the following several figures of the drawings.

FIG. 1 is a conceptual diagram of a network comprising multiple network devices with various sources of power in accordance with various embodiments of the disclosure;

FIG. 2A is a conceptual illustration of a network with a plurality of redundant network paths in accordance with various embodiments of the disclosure;

FIG. 2B is a conceptual illustration of a network with one or more powered off redundant paths in accordance with various embodiments of the disclosure;

FIG. 2C is a conceptual illustration of a network with one or more events triggering the generation of a sustainable network path score in accordance with various embodiments of the disclosure;

FIG. 2D is a conceptual illustration of a network with one or more powered off redundant paths based off a newly generated sustainable network path score in accordance with various embodiments of the disclosure;

FIG. 3 is a conceptual illustration of a plurality of transport subsystems within a network in accordance with various embodiments of the disclosure;

FIG. 4 is a flowchart depicting a process for powering off redundant network paths within a network in accordance with various embodiments of the disclosure;

FIG. 5 is a flowchart depicting a process determining an availability profile in accordance with various embodiments of the disclosure;

FIG. 6 is a flowchart depicting a process for generating a sustainable network path score in accordance with various embodiments of the disclosure;

FIG. 7 is a flowchart depicting a process for determining when to power off redundant network paths in accordance with various embodiments of the disclosure; and

FIG. 8 is a conceptual block diagram of a device suitable for determining and powering down redundant network paths within a network.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements to facilitate understanding of the various presently disclosed embodiments. In addition, common but well-understood elements that are useful or necessary in a commercially feasible embodiment are often not depicted in order to facilitate a less obstructed view of these various embodiments of the present disclosure.

### DETAILED DESCRIPTION

In response to the issues given above, various devices, methods, processes, and/or embodiments described herein can provide for selectively depowering any path and/or device that seem unnecessarily redundant to strike a balance between resiliency and sustainability to reduce energy costs. The analyses involved may include determining what the current application mix in use on network paths. For example, a policy may be maintained that at least two available paths are actively energized when real-time collaboration applications (“apps”) are running. Examples of these real-time collaboration apps may include data mining in an online database stored elsewhere in the network or holding a video conference call. This failover, double path redundancy can often deliver 99.999% application availability. Conversely, when just web/email are actively running, the user experience may be maintained with just a backup network path that can be energized in less than one second should a primary network path lose connectivity. Thus, different types of applications have different levels of resiliency to network path outages/depowerings. Thus, when determining which network paths may be redundant and suitable for powering down (either in sleep mode, lower-power mode, or fully off), the types of applications should be considered. By taking these aspects into consideration, various methods described herein can also provide an equivalent 99.999% application availability.

Each application may have its own Service-Level Agreement (SLA), which could include a plurality of selection criteria such as guaranteed latency, data throughput, and the availability of a path through the network meeting the specifications of the SLA. The selection criteria could also comprise several metrics to establish availability, including for example, an uptime percentage, which generally refers to a percentage of time that an application is available to users. For example, an SLA might specify that the application must be available 99.9% of the time, which equates to a maximum of 43 minutes and 50 seconds of downtime per month.

In some embodiments, calculating the Mean Time Between Failures (MTBF) may be beneficial. The MTBF which generally refers to the average time between failures of the application. It may be calculated by dividing the total uptime by the number of failures. Those skilled in the art will appreciate that this metric may be useful for predicting the likelihood of future failures and can be used to inform maintenance schedules and infrastructure upgrades. Similarly, the Mean Time To Recover (MTTR) may be utilized, which generally refers to the average time it takes to recover from a failure. The MTTR may include the time to detect, diagnose, and repair the issue. This metric may be useful for measuring the efficiency of the incident response process and identifying areas for improvement.

In some embodiments, a simple measure such as response time may be utilized to determine the time it takes for the application to respond to user requests. Those skilled in the art will appreciate that this metric is particularly useful for applications that require real-time processing, such as financial trading platforms and/or video streaming services. Performance metrics, such as CPU usage, memory usage, and network latency, can also be used to establish availability requirements and help ensure that the application is performing optimally and can handle peak loads.

Path availability is an important metric for evaluating the reliability and performance of a network, as it may determine the ability of devices to communicate with each other and exchange data. Path availability may be affected by various factors, such as network congestion, hardware failures, software issues, and environmental factors. For example, if a particular path between two devices in a network experiences congestion or bandwidth limitations, the path availability may be reduced, resulting in slower or unreliable communication between the devices. Similarly, if a hardware failure occurs on a network device that is responsible for routing traffic along a particular path, the path availability may be affected, potentially causing network disruptions.

To ensure high path availability, network administrators may employ various strategies, such as load balancing, redundancy, and failover mechanisms. Load balancing involves distributing network traffic across multiple paths or routes to prevent congestion and ensure optimal performance, while redundancy involves using multiple devices or links to provide backup options in case of failures. Failover mechanisms automatically switch traffic to alternate paths or devices in case of failures or disruptions, further improving the overall availability of the network.

In many embodiments, data travels between devices through a point-to-point connection. These connections can allow data to flow between the devices without any intermediary devices such as switches or routers. This type of communication is often used in telecommunications and computer networking, and can be implemented using dedicated circuits, leased lines, or virtual private networks (VPNs).

A point-to-point path can provide a high-speed, reliable connection between two devices, with a dedicated bandwidth and no interference from other devices on the network. It is commonly used for transmitting sensitive data, such as financial transactions, medical records, and government communications, as well as for remote access to corporate networks, cloud services, and other resources.

A point-to-point path can be physical or logical. In a physical point-to-point connection, two devices are connected directly with a cable or wire, such as in a serial connection between two routers. In a logical point-to-point connection, two devices communicate directly with each other over a shared network medium, such as in a VPN (Virtual Private Network) connection between two remote offices.

Point-to-point paths are often used in situations where high-speed and reliable communication between two devices is required, such as in a private network connection between two data centers, or in a leased line connection between two offices. They are also commonly used in wireless communication systems, where a direct connection between two devices can provide better performance and security than a connection through an intermediate network device.

In additional embodiments, a network path can refer to the route that data takes as it travels between two devices on a network, which may be across a plurality of point-to-point paths. The network path can consist of a series of network devices, such as routers, switches, and bridges, that the data must pass through to reach its destination.

When a device on a network sends data to another device, the data is often broken up into packets, each of which is sent separately over the network. Each packet is sent from the source device to a router or switch, which forwards it to the next device on the path based on the destination address contained in the packet header. This process continues until the packets reach their destination device.

The network path can have multiple routes, and the path taken by the data can change dynamically depending on factors such as network traffic, device availability, and network topology. Network paths can be altered using routing protocols, which may determine various paths for the data to take based on network conditions and other factors.

In further embodiments, a transport subsystem can be understood as being responsible for the reliable and efficient transmission of data between two devices over a network. The transport subsystem can provide end-to-end communication services that ensure that data packets are delivered correctly and in the correct order. This results in it being responsible for establishing and managing connections between two devices, as well as ensuring that data is delivered in a timely and reliable manner.

The transport subsystem is typically implemented using protocols such as, but not limited to, TCP (Transmission Control Protocol) and UDP (User Datagram Protocol). TCP is a connection-oriented protocol that provides reliable data transmission by establishing a connection between two devices and using mechanisms such as acknowledgments and retransmission to ensure that data is delivered correctly. UDP, on the other hand, is a connectionless protocol that provides best-effort delivery of data without any guarantee of reliability.

In many embodiments, a process for determining redundant network paths may include generating a plurality of profiles, metrics, and/or scores that can be processed to facilitate the determination of various aspects of a network. By way of non-limiting example, in-line transport point-to-point path options between sets of devices within a managed network can be identified for processing. For each of these identified network path options, an availability profile can be determined. In a number of embodiments, this determination can be done based on the most stringent SLA (i.e., those that require the highest level of availability). In some embodiments, the following formula may be utilized wherein A is an availability profile P2P is a point-to-point path, and Trans. Sub is a transport subsystem:

A(Network Path)=A(Highest Availability SLA of Point-to-Point Paths Group) (1)

Thus:

$$A ( Network Path ) > 1 - ( ( 1 - A ( P 2 P Path \#1 ) ) * ... ( ( 1 - A ( P 2 P Path \# n ) \qquad ( 2 )$$

Wherein each P2P path can be calculated as:

$$A ( P 2 P Path ) = A ( Trans . Sub \#1 ) + A ( Trans . Sub \#2 ) ... A ( Trans . Sub \# n ) \qquad ( 3 )$$

and each transportation subsystem availability can be determined as:

A(Trans. Sub)=A(Overlapping Resource Loss, Convergence Time, Availability) (4)

such that:

A(Overlapping Resource Loss)=ƒ(mean time of repair per #of devices/links) (5)

A(Convergence Time)=ƒ(frequency of loss per #of device/links) (6)

A(Availability)=ƒ(product of every transport controller) (7)

More specifically, the A(Overlapping Resource Loss) and A(Convergence Time) can be understood as items that can and will have an impact that will hit the full duration of the flow, even though flow duration is often not a factor in SLAs. Additionally, the A(Availability) can be understood as items that have an impact at flow initiation and/or reauthorization, such as establishing a domain name system (DNS) connection, as well as authentication, authorization, and accounting (AAA) steps.

In further embodiments, a power expenditure metric can be determined. This can be generated in response to the expected bandwidth over a given period of time. This can occur at a network path level, but is often done at a transport subsystem level. It is contemplated that certain components within transport subsystems can sometimes be configured to dynamically change or re-adjust their connectivity and associated energy usage based on immediate bandwidth needs. In these instances, it can be assumed that these components can react quickly enough to power down that they may be considered to be outside the bounds of evaluation utilizing the above formulas and/or systems.

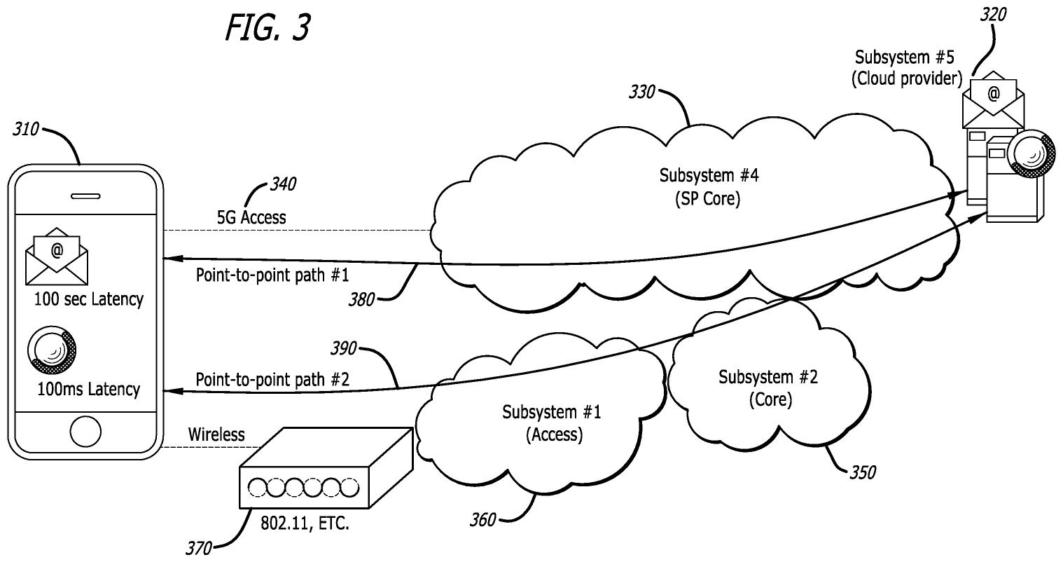

In various embodiments, the power expenditure metric can be determined such that the least power subsystems can be determined across the sum of all transport subsystems which satisfy the equation (2). In additional embodiments, a result for equation (2) may be required for each pair of network edges or edge devices which need a transport SLA supported between them. A single pair of network edge devices are shown in more detail within the discussion of FIG. 3 below.

It is contemplated that the results from these equations can be built up to and stored to aggregate a set of such equation results, which can subsequently be utilized to determine whether a network path is redundant and can be powered down. Those skilled in the art will also recognize that a transportation subsystem can itself comprise a plurality of subsystems such as component subsystems which may also be powered down in lieu of the entire transportation subsystem being powered down.

Finally, a sustainable network path score can be generated that can utilize the determined power expenditure metric and/or availability profile for each point-to-point, network path, or transportation subsystem option. The generation of this sustainable network path score can be done over a predetermined period of time, or in near real-time based on the needs of the desired application. In certain embodiments, the sustainable network path score may be a score that can be compared against a threshold such that having a score that exceeds the threshold indicates that powering down is not a viable option, etc. However, it is contemplated that other thresholds, processes, and/or evaluations of the generated sustainable network path score can be utilized as needed to facilitate reduced energy usage over time.

In more embodiments, a topology heatmap may be utilized to facilitate the generation of various metrics, scores, profiles, etc. As those skilled in the art will recognize, a topology heatmap can be a graphical representation of network topology data that visualizes the density of network connections or traffic in a particular area of the network. This can show a network map overlaid with a color-coded gradient that represents the intensity of network traffic or connections in each area of the network. The heatmap is generated based on data collected from network devices such as switches, routers, and firewalls, and can provide insights into network traffic patterns, congestion, and potential bottlenecks.

While useful for network administrators and engineers to quickly identify areas of the network that are experiencing high levels of traffic or congestion, this information may also be utilized to optimize the network routing, adjust bandwidth allocation, identify network devices that may be causing issues, or generate various data scores etc. by blending neighboring data when warranted.

In still more embodiments, the process of determining and selecting network paths and their associated components for powering down can include reassessing those determinations based on a variety of predefined events. These events may include, but are not limited to, expiration of a predetermined amount of time, a change in the sustainability attributes associated with the network or a given device, a newly detected network failure, and/or when a new SLA is added to the network. Based on these events, a new set of availability profiles and power expenditure metrics may be determined, and a new sustainable network path score can be generated.

These determinations on whether a network path, and any associated links is redundant can be made in a variety of ways and powered down through various means. In a number of embodiments, a loop-free alternative (LFA) tree can be utilized to power off various paths, links, hops, etc. In more embodiments, a LFA ring may be utilized. As those skilled in the art will recognize, LFA rings and LFA trees are often used for fast rerouting in the event of a network link or node failure. However, there are some differences between them.

An LFA tree is often considered a data structure used in the “Segment Routing with MPLS data plane (SR-MPLS)” routing protocol or the like to find the best backup path to a destination node, while avoiding loops and ensuring traffic is forwarded along the shortest path possible. The LFA tree can be constructed by each router in the network, and it identifies the best alternate path for each destination.

On the other hand, an LFA ring may be considered a data structure used in the “Link Aggregation Control Protocol (LACP)” or the like to provide loop-free and resilient Ethernet link aggregation. It is often designed to ensure that the Ethernet frames are forwarded without loops in a link aggregation group (LAG) consisting of multiple links.

In an LFA ring, each link in the link aggregation group is assigned a role, either “forwarding” or “backup,” based on its position in the ring. The forwarding link is responsible for carrying the data traffic, while the backup link is kept in reserve in case the forwarding link fails.

The key difference between the LFA tree and the LFA ring is that the LFA tree is often used for rerouting in a routed network, while the LFA ring is typically used for loop prevention and failover in an Ethernet link aggregation group. Additionally, the LFA tree can be constructed by each router in the network, while the LFA ring may be constructed by the switches in the Ethernet link aggregation group.

In certain embodiments, to understand dhow an LFA tree can be utilized to depower any links or paths, an L3 spanning tree can be considered. This tree may have stretched routes rooted at the control point and possibly at one or more major internet connections as well. This may allow for a mix of radio access technologies to be incorporated into the redundancy plan, as it typically done in many networks. This base topology can ensure connectivity. However, we can depower any link that is not on the tree and use the stretched path in the base topology. More direct paths can be enabled under control of a controller or other ecosystem management tool via additional topologies/routing information bases that can enable additional links/paths.

In a number of embodiments, level 2 (L2) hops can be automatically enabled. This can be done by computing, via a controller or other ecosystem management tool, a topology that includes sleeping/powered off links/paths, and setting them on a spanning tree prior to measuring them. Subsequently, the controller or ecosystem management tool can activate and enable the topology to enable data flows within. These links/paths can then be utilized in additional topologies/routing information bases.

In embodiments that utilize LFA rings, any link or 2 hop path between nodes along the ring may be depowered. This can be similar to the LFA tree embodiments, but may be designed as a spanning bubble network. In other words, a network of rings can be determined which touch one another, span the network, and mark them as non-redundant. Spanning tree methods can still be conducted along the rings. Likewise, any link or 2 hop paths between nodes along the ring may be turned off and replaced by traffic along the rings.

In further embodiments, one or more machine-learning methods can be utilized to select specific transport subsystems and related elements to depower via a prediction prior to any SLA being negatively impacted and/or violated. Through the use of predictive analytics, specific links/paths that were selected for depowering in order to optimally load them as opposed to lightly load them, can be re-energize/powered on. Re-powering a link/path can be done through events such as DNS lookups, AP associations, time of day, etc.

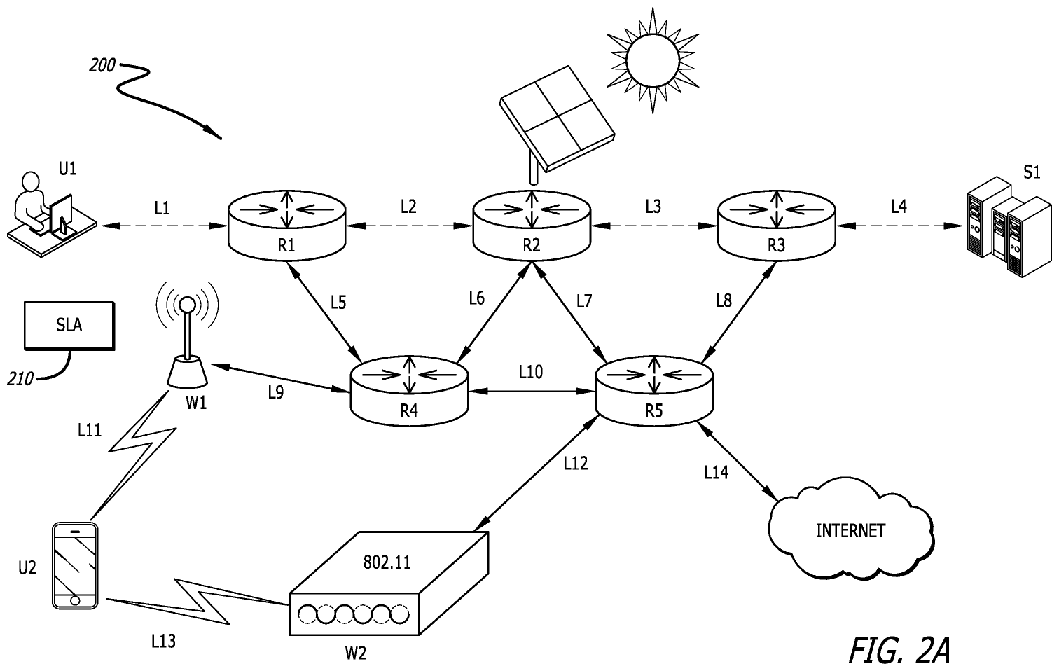

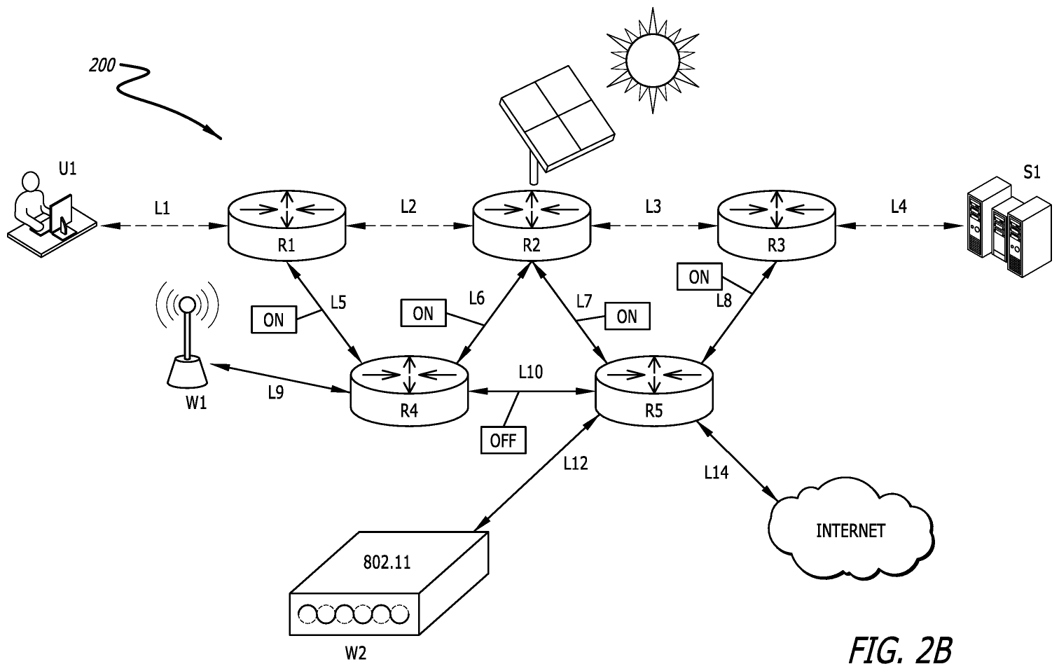

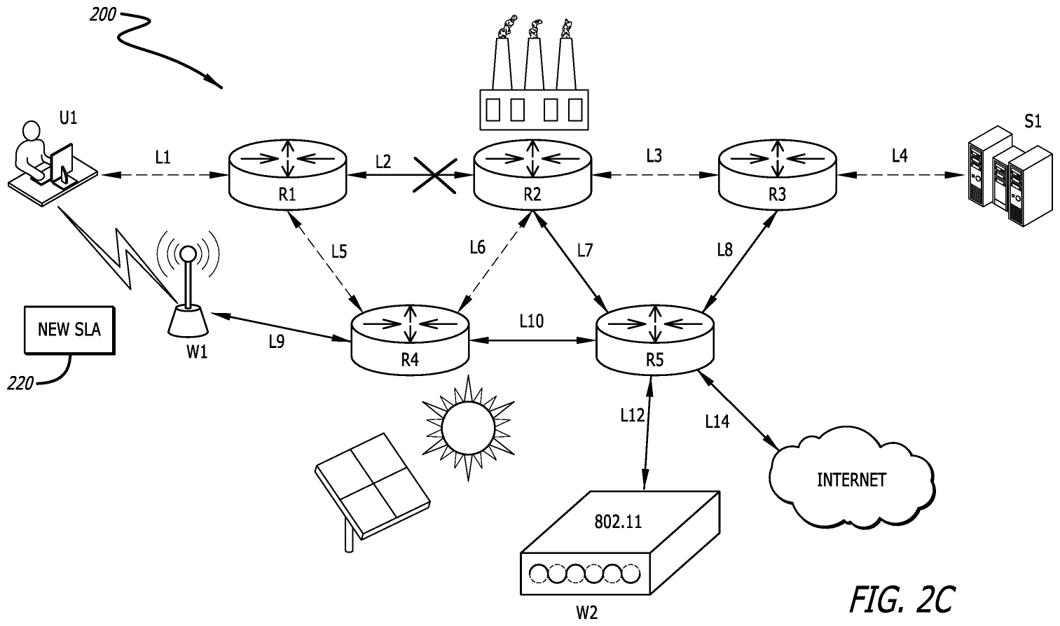

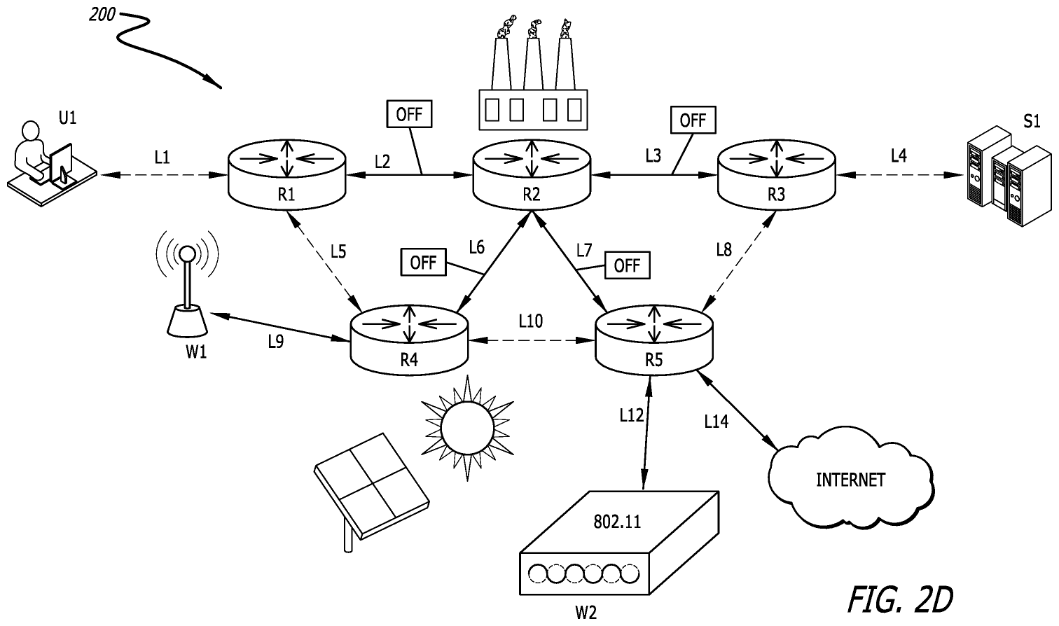

Although various aspects and embodiments herein discuss determining redundant network paths and powering them down to save energy while maintaining uptime and user experiences, it will be recognized (and is contemplated) by those skilled in the art that other components, such as point-to-point paths, transport subsystems, and the like may also be selected as being redundant and powered down. For example, in the embodiments depicted in FIGS. 2A-2D, point-to-point paths are shown as being powered on and off. However, this may apply as part of a network path. In this way, when a network path is selected as redundant, parts of that path may reside in a non-redundant network path, and as such, those point-to-point paths within the network path that overlap non-redundant network paths can remain powered on. Thus, only part of the redundant network path may actually be powered down, even when the entire network path is selected as redundant and suitable for powering off.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “logic,” “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations, which, when joined logically together, comprise the function and achieve the stated purpose for the function.

Indeed, a function of executable code may include a single instruction or many instructions and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but is not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computers and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

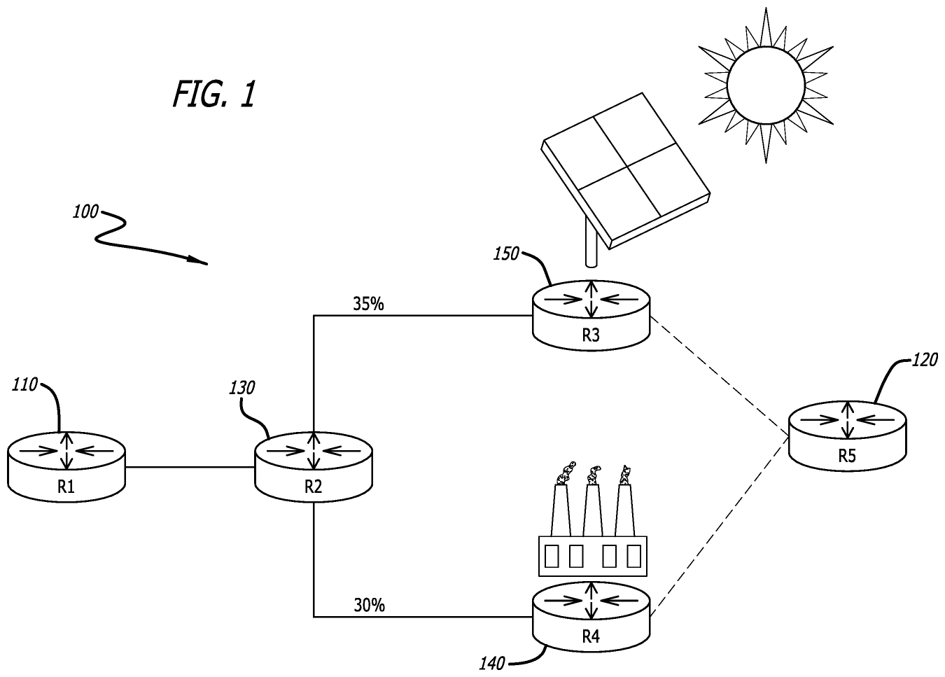

Referring to FIG. 1, a conceptual diagram of a network comprising multiple network devices with various sources of power in accordance with various embodiments of the disclosure is shown. The network 100 can include a plurality of devices, e.g., routers 110, 130, 140 and 150, which can be in communication with each other and/or a remote server, such as a cloud-based server 120. The network 100 depicted in FIG. 1 is shown as a simplified, conceptual network. Those skilled in the art will understand that a network 100 can include a large variety of devices and be arranged in a virtually limitless number of combinations based on the desired application and available deployment environment.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Traditionally, devices operating within a network 100 have not considered various aspects of operation that can relate to the overall sustainability of the network. For example, devices in communication networks have often used grid-supplied energy as a primary power source. This grid-supplied energy can regularly provide energy that has been generated by a negative environmental impacts-heavy power source such as a coal-powered power plant. However, modern power grids often have more diverse and cleaner energy sources for the provided generated energy. Some devices can still be powered by power sources that utilize fossil fuels, such as the router R4 140 as depicted in FIG. 1. Alternatively, some devices can operate by using renewable sources of energy, such as the router R3 150 which is conceptually depicted as being powered by solar power.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

In the embodiment depicted in FIG. 1, the operation of a coal-powered power plant will create a sizeable amount of negative environmental impacts in the form of carbon emissions and the like. Contrast that with a solar array which may not create emissions when generating electricity, but may negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

Another measurement of negative environmental impacts that can be utilized when comparing power sources is to determine the amount of greenhouse or carbon emissions released per unit of electricity generated. Specifically, various embodiments described herein may utilize the CO₂e kg/kWh metric which measure the amount of kilowatt hours produced per kilogram of carbon dioxide gases released into the environment. Therefore, when discussing a negative environmental impacts-heavy power source compared to a clean(er) power source, the clean power source can, for example, have a better CO₂e kg/kWh rating compared to the negative environmental impacts-heavy power source. Utilizing a cleaner power source thus provides for a more sustainable network operation.

In order the maximize the overall sustainability of a network, it may be desirable to increase the use of cleaner power sources with a lower overall negative environmental impact as opposed to power sources with a higher overall negative environmental impact when operating the network. Thus, there can be a need to be aware of the source of energy provided at each device along the route of data travel. Additionally, other factors such as the attributes unique to each device can be factored in, along with the current and/or expected traffic, etc. Once known, an optimal method of traversing the data may need to be calculated. As discussed in more detail, this path algorithm can be utilized to better optimize the locations selected within a network for data travel.

Other methods may be utilized to increase sustainability in network operations. In many embodiments, the network devices themselves may have one or more features or other capabilities that can allow for a more efficient operation. For example, a network router may be operated in a lower power mode or be powered off entirely for a specific period of time or until an event occurs. Additional embodiments may utilize various other power-saving capabilities that can be turned on or off remotely or in response to an event or predetermined threshold being exceeded. Often, operations performed by the network devices can be utilized in scenarios where network performance will not be affected or is affected such that no loss in user experience occurs. By utilizing less power during operation, a higher level of sustainability can be achieved.

Together, the type of power source providing electricity to a network device, along with the various sustainability-related capabilities of the router can be understood as the sustainability-related attributes of that network device. During operation, one or more devices within the network may seek and collect the sustainability-related attributes of various network devices, which can provide insight into both the type of power source providing power to the device, but also the various capabilities of the network device that may be activated to provide more efficient operation.

Additionally, when generating various scores, metrics, or other evaluations of the network devices within a network 100, the sustainability-related attributes can vary based on a variety of factors such as the time of day, current network traffic, expected network traffic, and historical usage patterns. For example, a network router may receive energy from a solar power source during the day but receives energy from a coal-powered power plant at night. In these instances, an averaged score may be used, or a unique score may be generated at the time of operation. In another example, network traffic may be such that removing one or more network devices from the optimal sustainable data paths may negatively affect user experiences, such as when a sporting event occurs. As such, scores may be generated at numerous times depending on the desired application. Often, the act of measurement may negatively affect sustainability such that determining the proper amount of measurements for a given outcome may be determined.

Although a specific embodiment for a network 100 is described above with respect to FIG. 1, any of a variety of systems and/or processes may be utilized in accordance with embodiments of the disclosure. For example, the network could be broken into a plurality of partitions, wherein each partition could have specific needs, service level agreements, etc. that can alter sustainability-optimization. The elements depicted in FIG. 1 may also be interchangeable with other elements of FIGS. 2-8 as required to realize a particularly desired embodiment. Augmented protocols to carry out these described processes are described below.

Referring to FIG. 2A, a conceptual illustration of a network with a plurality of redundant network paths in accordance with various embodiments of the disclosure is shown. In many embodiments, the network 200 may comprise five routers R1, R2, R3, R4, and R5. The embodiment depicted in FIG. 2A also comprises two user computing devices U1 and U2, two wireless transceivers W1 and W2, a server S1, and a plurality of network links between them all. It should be understood that any number of computing devices, wireless transceivers, servers, and links may be used, without exceeding beyond the spirit and scope of the instant disclosure.

There are several types of link connections that can be used in network environments to connect devices to a network, without limitation. For example, the link connections L1-L14 described herein may comprise Ethernet, Wi-Fi, Bluetooth, Fiber-optic, USB, and/or Infrared. More specifically, link L1 may be a hardware or wireless connection between user computing device U1 and router R1. This connection may be Ethernet (10/100/1000/10G) or some other protocol, without limitation.

Similarly, link L2 may be a hardware connection between router R1 and router R2. Link L3 may be a hardware connection between router R2 and router R3, while link L4 may be a hardware connection between router R3 and server S1. Link L5 can be a hardware connection between router R1 and router R4, while link L6 may be a hardware connection between router R2 and router R4. Additionally, link L7 may be a hardware connection between router R2 and router R5 and link L8 may be a hardware connection between router R3 and router R5. Link L9 may be a hardware connection between router R4 and wireless transceiver W1. Link L10 may be a hardware connection between router R4 and router R5. Furthermore, link L11 may be a wireless connection between wireless transceiver W1 and user computing device U3 and link L12 may be a hardware connection between router R5 and wireless transceiver W2. Finally, Link L13 may be a wireless connection between wireless transceiver W2 and user computing device U2 while link L14 may be a hardware connection between router R5 and the Internet. These links may be wired or wireless, utilizing protocols such as, but not limited to, Ethernet (10/100/1000/10G) Wi-Fi, Bluetooth, etc.

The above links are described in relation to the embodiment depicted in FIG. 2A, but as those skilled in the art will recognize, a network 200 may have any variety of network devices within a given domain, wherein each device may be connected to each other through a variety of means sufficient to establish communication. Additionally, either one of the user devices U1, U2 may be executing or otherwise operating a client application that can be configured to expect or operate a service level agreement (SLA) 210. In more embodiments the device itself may be associated with an SLA 210. Furthermore, the data being transferred between U1 and S1 is shown as travelling along the links with dashed lines such that links L1, L2, L3, and L4 are utilized to exchange data between the two endpoint devices U1 and S1. Finally, the embodiment depicted in FIG. 2A indicates that router R2 is powered by energy received from a solar-based power source. As will be shown below, variations of network 200 can be utilized to illustrate various features or aspects of the disclosure.

Referring to FIG. 2B is a conceptual illustration of a network 200 with one or more powered off redundant paths in accordance with various embodiments of the disclosure is shown. In many embodiments, each network path may be evaluated such that individual links can be powered down. In the conceptual embodiment depicted in FIG. 2B, the various network paths may be evaluated for redundancy with respect to power sources utilized, the SLA requirements of a user device and/or application, or the available network paths within the managed network 200.

In the embodiment depicted in FIG. 2B, the network 200 is shown with a connection between user computing device U1 and server S1 passing through routers R1, R2, and R3 via links L1, L2, L3, and L4. In some embodiments the user computing device U1 may be running a real-time collaboration application or other application that has a demand for a high-availability SLA. Thus, links L5, L6, L7, and L8 may remain powered on as part of one or more alternative network paths so that they are ready to reroute the data during a failover. These powered on links are indicated by the “ON” label. In response, since link L10 is not a part of either the link L2 or link L3 failover network paths, it may be determined that it is redundant and can therefore be powered down as indicated by the “OFF” label. In further embodiments, such as when the user computing device U1 is running a web/email type of application with a much lower SLA availability requirement, it may be determined that links L5, L6, L7, and L8 can be powered down until needed (not shown in the figure).

As described above, these determinations on whether a network path, and any associated links is redundant can be made in a variety of ways. In a number of embodiments, a loop-free alternative (LFA) tree can be utilized to power off various paths, links, hops etc. In more embodiments, a LFA ring may be utilized. As those skilled in the art will recognize, LFA rings and LFA trees are often used for fast rerouting in the event of a network link or node failure. However, there are some differences between them.

Referring to FIG. 2C, a conceptual illustration of a network 200 with one or more events triggering the generation of a sustainable network path score in accordance with various embodiments of the disclosure is shown. As discussed previously, one or more events may occur that trigger the reevaluation of a network configuration. During the normal operation of the network, a number of network paths may be determined to be redundant and powered down, such as in the embodiments of FIG. 2B. Subsequently, an event can change the makeup of the network such that the previously powered down redundant network paths may require to be powered on in order to maintain the required SLA and/or user experience levels.

As such, the embodiment depicted in FIG. 2C include a plurality of events that can trigger a network reassessment. In some embodiments, the network 200 may acquire a new SLA 220 which may have a more stringent, or higher level of required availability. As a result, the current mix of redundant network paths may not be sufficient to acquire the required SLA availability.

In additional embodiments, it may be detected that a network break occurs, such as the break in the link L2. When a break occurs in a network link, the traffic that was previously flowing through that link needs to be rerouted in order to maintain network connectivity. The specific method for rerouting traffic will depend on the type of network and the protocols being used, but there are several common approaches that can be taken. As a result, the network path between U1 and S1 is rerouted from L1 to L5 at R4 to L6 to R2 and then through L3 to R3 before utilizing L4 to arrive at S1. One common method for rerouting traffic is to use a redundancy protocol such as Spanning Tree Protocol (STP) or Rapid Spanning Tree Protocol (RSTP). These protocols are designed to detect network loops and prevent them from occurring by blocking certain network links. As those skilled in the art will appreciate, when a link fails, the protocol will automatically unblock a previously blocked link to establish a new path for traffic to flow through.

Another method for rerouting traffic is to use link aggregation, also known as port bonding or NIC teaming. Link aggregation allows multiple network links to be combined into a single logical link, providing increased bandwidth and redundancy. When a link fails, the traffic that was previously flowing through that link can be automatically rerouted to the remaining links in the link aggregation group. In some cases, network administrators may manually reroute traffic using routing protocols such as OSPF or BGP. These protocols allow administrators to define alternate paths for traffic to flow through, which can be used in the event of a link failure. It will be appreciated that the specific method for rerouting traffic will depend on the network configuration and the protocols being used. However, the goal is to establish a new path for traffic to flow through in order to maintain network connectivity and minimize disruptions to network operations.

In further embodiments, the router R2 was previously powered by a solar power source. However, in the embodiment depicted in FIG. 2C, the router R2 is now powered by a coal-based power source (such as during the night time, etc.) whereas router R4 is now powered by solar power. As a result, the sustainability attributes associated with each of those network devices may change and require a reassessment of the profiles, metrics, and/or scores involved in determining if a network path is redundant. As such, in certain embodiments, the network path selected in the embodiment of FIG. 2C may continue to be desired, even if the network break at L2 was not present. Based on this new network path and configuration within the network 200, a new set of redundant network paths and associated links may be determined.

Referring to FIG. 2D, a conceptual illustration of a network with one or more powered off redundant paths based off a newly generated sustainable network path score in accordance with various embodiments of the disclosure is shown. In many embodiments, each network path may again be evaluated such that individual links can be powered down. In the conceptual embodiment depicted in FIG. 2D, the various network paths may be reevaluated for redundancy with respect to power sources utilized, the SLA requirements of a user device and/or application, or the available network paths within the managed network 200.

In the embodiment depicted in FIG. 2D, the network 200 is shown with a connection between user computing device U1 and server S1 passing through routers R1, R4, R2, and R3 via links L1, L5, L10, L8 and L4. In the embodiment depicted in FIG. 2D, no alternative network paths are needed, such as when the client application being operated by U1 does not have a high availability SLA, such as for example, when an email or web-based application is being used. As a result, links L2, L3, L6 and L7 are powered down, indicated by the “OFF” label.

As described above, these determinations on whether a network path, and any associated links is redundant can be made in a variety of ways. In a number of embodiments, as described in more detail throughout, an availability profile and power expenditure metric can be determined which may both be utilized to generate a sustainable network path score. The sustainable network path score can be used to sort and/or otherwise classify which network paths or corresponding elements are considered redundant. In a number of embodiments, this can be done by comparing each sustainable network path score against a threshold score. Once the redundant network paths are selected, each point-to-point path or other component can be overlapped and compared to determine if a non-overlapped component is present which can then be powered down within the network paths. Similarly, transport subsystems may also be evaluated for powering down, which are described in more detail below.

Although specific embodiments are described above with respect to FIGS. 2A-2D, any of a variety of systems and/or processes may be utilized in accordance with embodiments of the disclosure. For example, the network 200 may include any number of network devices and/or links, connection, network paths, etc. Indeed, the example network 200 depicted in FIGS. 2A-2D are simplified in order to illustrate various concepts. The aspects described in FIGS. 2A-2D may also be interchangeable with other elements of FIGS. 1 and 3-8 as required to realize a particularly desired embodiment.

Referring to FIG. 3, a conceptual illustration of a plurality of transport subsystems within a network in accordance with various embodiments of the disclosure is shown. In many embodiments, the network can include two edge devices that are in communication such as a mobile computing device 310 (i.e., smart phone) and a cloud provider 320. The mobile computing device 310 can operate multiple applications. The embodiment depicted in FIG. 3 shows the mobile computing device 310 operating an email application and a real-time collaboration application. Each application can send and receive data with the cloud provider 320.

The email application may require a lower level of availability than the real-time collaboration application. Each of the applications may have a unique point-to-point path. Specifically, the email application may have a first point-to-point path 380 that connections through a 5G access connection 340 and through a service provider (SP) core transport subsystem 330. Conversely, the real-time collaboration application may require a higher level of availability, often through an SLA. The real-time collaboration application may have a second point-to-point path 390 which can go through a wireless access point 370 and through a first access transport subsystem 360 and through a second core transport subsystem 350 and through the SP core transport subsystem 330 until it reaches the cloud provider 320. Thus, in order to achieve similar levels of availability (i.e., uptime), more network paths and associated components may be found to be redundant on the first point-to-point path 380 since the email application can continue operations with longer network interruptions, compared to the real-time collaboration application which would likely have fewer redundant network paths and associated components on the second point-to-point path 390.

Each of these transport subsystems may represent different parts of a network that can be configured to transport data between various network devices. Transport subsystems can be considered the physical infrastructure necessary that transported data physically crosses. Thus, the network paths can be understood as a conceptual set of the physical components or “route” that the data may travel through from one sending device to another destination device. Point-to-point paths may be considered part of a network path that can connect two specific devices that can facilitate data flow along a network path. However, in some embodiments, the network path may simply be a point-to-point path as no intermediary devices may be present between the sending device and the destination device.

Although specific embodiments are described above with respect to FIG. 3, any of a variety of systems and/or processes may be utilized in accordance with embodiments of the disclosure. For example, the embodiment depicted in FIG. 3 is overly simplified in order to highlight the relationship between point-to-point paths, transport subsystems, network paths, and the like. Indeed, any number of point-to-point connections, network paths, and transport subsystems may be found between two devices on a network. The aspects described in FIG. 3 may also be interchangeable with other elements of FIGS. 1-2D and 4-8 as required to realize a particularly desired embodiment.

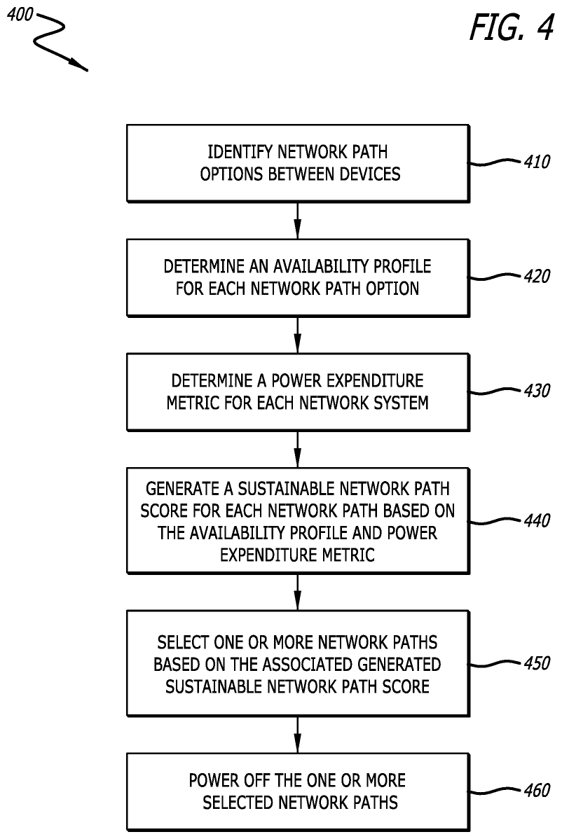

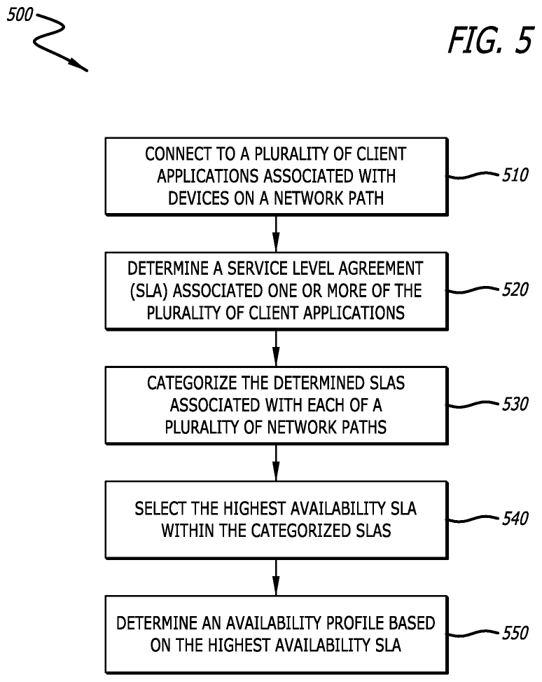

Referring to FIG. 4, a flowchart depicting a process 400 for powering off redundant network paths within a network in accordance with various embodiments of the disclosure is shown. In many embodiments, the process 400 can identify network path options between devices (block 410). As shown in the simplified embodiments in FIGS. 2A-2D, different end points within a network may have a plurality of path options that data can be transferred along. In a number of embodiments, the process 400 can determine an availability profile for each network path option (block 420). The process for determining an availability profile is detailed within the discussion of FIG. 5 below.

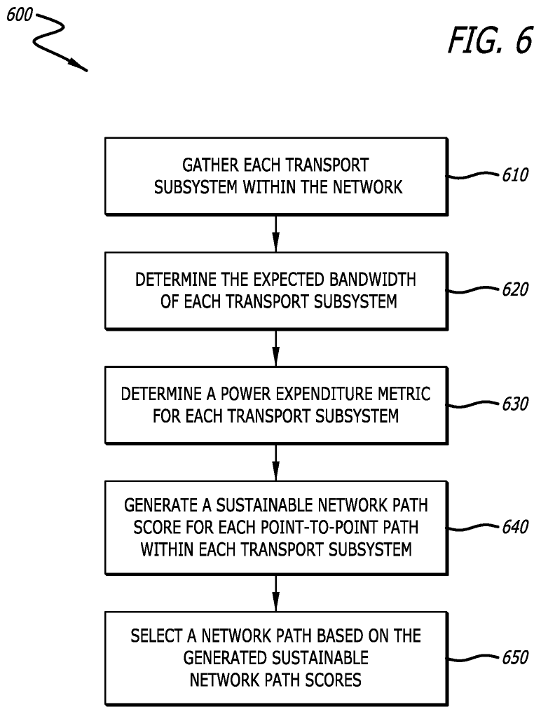

In additional embodiments, the process 400 can determine a power expenditure metric for each network system (block 430). Often, determining a power expenditure metric includes evaluating one or more transport subsystems within a network. However, this evaluation is discussed in more detail below with respect to FIG. 6. In further embodiments, the process 400 can generate a sustainable network path score for each network path based on the availability profile and power expenditure metric (block 440). As discussed previously, a sustainable network path score can be utilized to evaluate and/or compare various network paths within a network. In more embodiments, the process 400 can select one or more network paths based on the associated generated sustainable network path score (block 450). In response to a selection being made, the process 400 can power off the one or more selected network path (block 460).

Although specific embodiments are described above with respect to FIG. 4, any of a variety of systems and/or processes may be utilized in accordance with embodiments of the disclosure. For example, the process 400 may be operated by a specialized device or can be limited to a managed network domain. Additionally, the various profiles, metrics, and scores can be based on a baseline service level agreement (SLA) and/or a desired sustainability level/score. The aspects described in FIG. 4 may also be interchangeable with other elements of FIGS. 1-3, and 5-8 as required to realize a particularly desired embodiment. A more detailed process for determining an availability profile is shown below.

Referring to FIG. 5, a flowchart depicting a process determining an availability profile in accordance with various embodiments of the disclosure is shown. In many embodiments, the process 500 can connect to a plurality of client applications associated with devices on a network path (block 510). Each client application may utilize different levels of service and/or internet connectivity and bandwidth. Thus, various embodiments of the process 500 can determine a service level agreement (SLA) associated with one or more of the pluralities of client applications (block 520). As those skilled in the art will recognize, an SLA is often a contract or agreement between a service provider and its customer that outlines the minimum acceptable level of service that the provider will deliver. The SLA can specify the services to be provided, the quality levels that must be met, the responsibilities of both parties, the procedures for monitoring and measuring performance, and the remedies or penalties for failing to meet the agreed-upon service levels.

Each network path can have one or more SLAs associated with them as it may be utilized by a client device during use. Therefore, in more embodiments, the process 500 can categorize the determined SLAs associated with each of a plurality of network paths (block 530). The categorization can be done in a number of ways. One way of categorization is to sort by the levels of availability required. For example, classification may be done in terms of uptime availability required, response time availability needed, and/or quality of service availability in terms of data transfer rates, latency, packet loss, etc. As such, a number of embodiments may select the SLA with the highest availability requirements within the categorized SLAs (block 540). In response to an SLA being selected, the process 500 can determine an availability profile based on that highest availability SLA (block 550). In this way, the availability profile can be compatible or commensurate with the requirements of the most stringent SLA within the network path.

Although specific embodiments are described above with respect to FIG. 5, any of a variety of systems and/or processes may be utilized in accordance with embodiments of the disclosure. For example, the process 500 may attempt to generate an availability profile based on a combination of different types of classifications. For example, an availability score may be generated based off of an SLA with a high uptime availability and an SLA with a high quality of service availability. The aspects described in FIG. 5 may also be interchangeable with other elements of FIGS. 1-4, and 6-8 as required to realize a particularly desired embodiment. A more detailed process for selecting a network path is shown below.

Referring to FIG. 6, a flowchart depicting a process 600 for generating a sustainable network path score in accordance with various embodiments of the disclosure is shown. As discussed above with respect to FIG. 3, networks may consist of a plurality of transport subsystems. Transport subsystems can be understood as a layer of one or more networking protocol stacks that provide reliable communication between two endpoints over an unreliable network. Often, the transport subsystem is responsible for ensuring that data is transmitted between two endpoints in a reliable and orderly fashion, and for handling any errors or congestion that may arise during transmission.

In many embodiments, the process 600 can gather each transport subsystem within the network (block 610). This gathering can be to generate a list or other database that can be accessed later for subsequent processing and/or decision making. In further embodiments, the process 600 can determine the expected bandwidth of each transport subsystem (block 620). For example, one type of protocol may have a higher bandwidth requirement than a transport subsystem that utilizes a second, different protocol.

In additional embodiments, the process 600 can determine a power expenditure metric for each transport subsystem (block 630). As discussed above with respect to FIG. 1, various sustainability metrics and/or attributes can be associated with devices within a network. As such, there may be preferences to utilize one network device over another when desiring to utilize less energy and/or more sustainable sources of energy. As such, a power expenditure metric can be generated based on these data points and can be configured to reflect both the potential energy used by the devices within the transport subsystem, but also the potential sources of that energy.

In more embodiment, the process 600 can generate a sustainable network path score for each point-to-point path within each transport subsystem (block 640). A point-to-point path within a network subsystem typically refers to a direct connection or link between two nodes in a network. For example, in a point-to-point network topology, each node is connected to exactly one other node, forming a direct link between the two endpoints. Thus, in various embodiments, for each of these network paths, a sustainable network path score can be generated based on the determined expected bandwidth, and the determined power expenditure metric for that network path.

Subsequently, further embodiments of the process 600 can select a network path based on the generated sustainable network path scores (block 650). By way of non-limiting example, the process 600 may compare the generated sustainable network path scores for each point-to-point path associated with each network path and sort by scores to select one or more network paths. As a result, various selected network paths may be powered on or off as needed to reduce overall power usage.

Although specific embodiments are described above with respect to FIG. 6, any of a variety of systems and/or processes may be utilized in accordance with embodiments of the disclosure. For example, the process 600 may generate a sustainable network path score dynamically such that selections of network paths occur in near-real time and can fluctuate based on new events and network needs. The aspects described in FIG. 6 may also be interchangeable with other elements of FIGS. 1-5, and 7-8 as required to realize a particularly desired embodiment. A more detailed process for determining when to power off a network path is shown below.

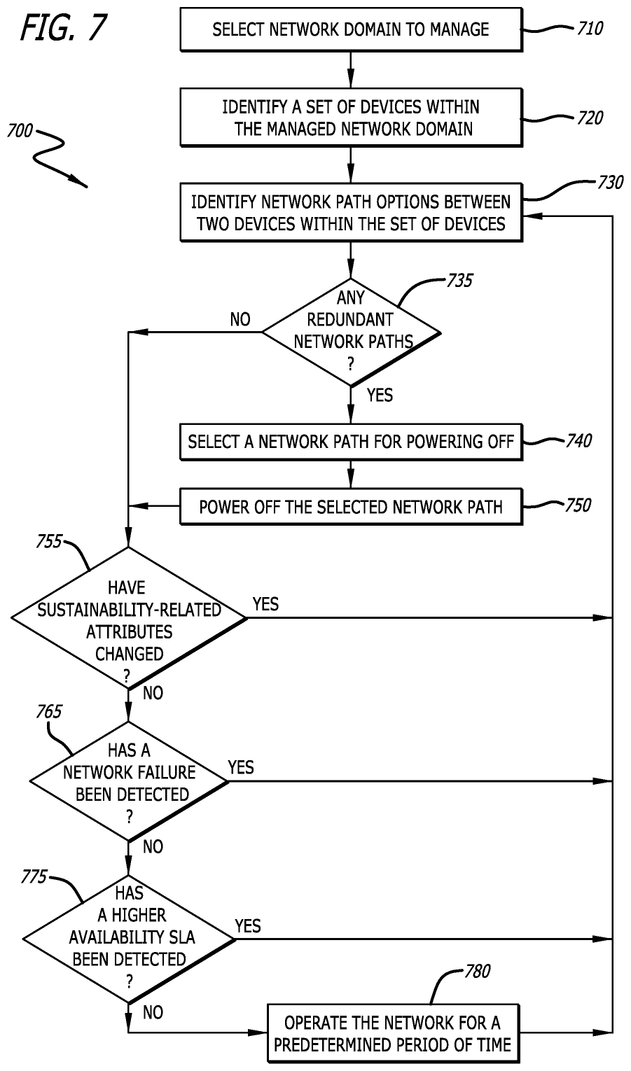

Referring to FIG. 7, a flowchart depicting a process 700 for determining when to power off redundant network paths in accordance with various embodiments of the disclosure is shown. In many embodiments, the process 700 can select a network domain to manage (block 710). As described above, the process 700 may not occur over an entire network. Indeed, various processes described herein can be applied to only a subset of devices within a network, such as a managed network domain that is operated by one or more administrators and/or controllers. As such, the process 700 may identify a set of devices within the managed network domain (block 720).

In response to identifying a plurality of network devices, various embodiments of the process 700 may identify network path options between two devices within the set of devices (block 730). In a number of embodiments, this step can be repeated until all network path options between all potential device pairs within the managed network domain are identified for additional processing. Additionally, the identification of various devices and/or network paths can be done by an ecosystem management tool or other network administrative device, tool, or system.

When a sufficient number of network path options have been identified, additional embodiments of the process 700 can determine if there are any redundant network paths (block 735). In some embodiments, this determination examines the need to reduce energy usage within the network. If it is determined that at least one network path is redundant, the process 700 can select a network path for power off (block 740). The process 700 may subsequently power off the selected network path (block 750).

However, when the process 700 determines that there are currently no redundant network paths or after redundant network paths have been powered off, the process 700 can determine if any sustainability-related attributes have changed within the network (block 755). If it is determined that a sustainability-related attribute has changed, then the process 700 can again identify network path options between two devices within the set of devices (block 730). In a number of embodiments, this can be based on a change in power source of one or more devices within the network, or a significant change in energy usage within one or more of those devices.

When the process 700 determines that no sustainability-related attributes have occurred, the process 700 can further determine if a network failure has been detected (block 765). As described above, a network failure may occur periodically that can require a re-routing of network signals over a different network path. If a network failure is detected, the process 700 can again identify network path options between two devices within the set of devices (block 730). However, when the process 700 determines that no network failure is present, a determination can be made if a higher availability SLA has been detected (block 775).

During normal operation of the network, one or more devices may be added or removed from the network. These newly added devices may have new SLAs that need to be evaluated with respect to the current network configuration. In more embodiments, existing devices on the network may execute or otherwise process new applications that may have new or more demanding SLAs that may also require a reassessment of the current network configuration. Thus, when a determination of a new SLA with a higher availability is present, the process 700 may again identify network path options between two devices within the set of devices (block 730). However, when no new high-availability SLA is detected, the process 700 can operate the network for a predetermined amount of time (block 780). The predetermined amount of time may be any suitable time to avoid negative effects on user experiences from a lack of reassessment of the state of the network.

Although specific embodiments are described above with respect to FIG. 7, any of a variety of systems and/or processes may be utilized in accordance with embodiments of the disclosure. For example, the process 700 may carry out the various determinations (changes in sustainability-related attributes, network failures, new SLAs, etc.) in any order as desired to facilitate the desired application. The aspects described in FIG. 7 may also be interchangeable with other elements of FIGS. 1-6, and 8 as required to realize a particularly desired embodiment. A device capable of executing the previously described processes is described below.

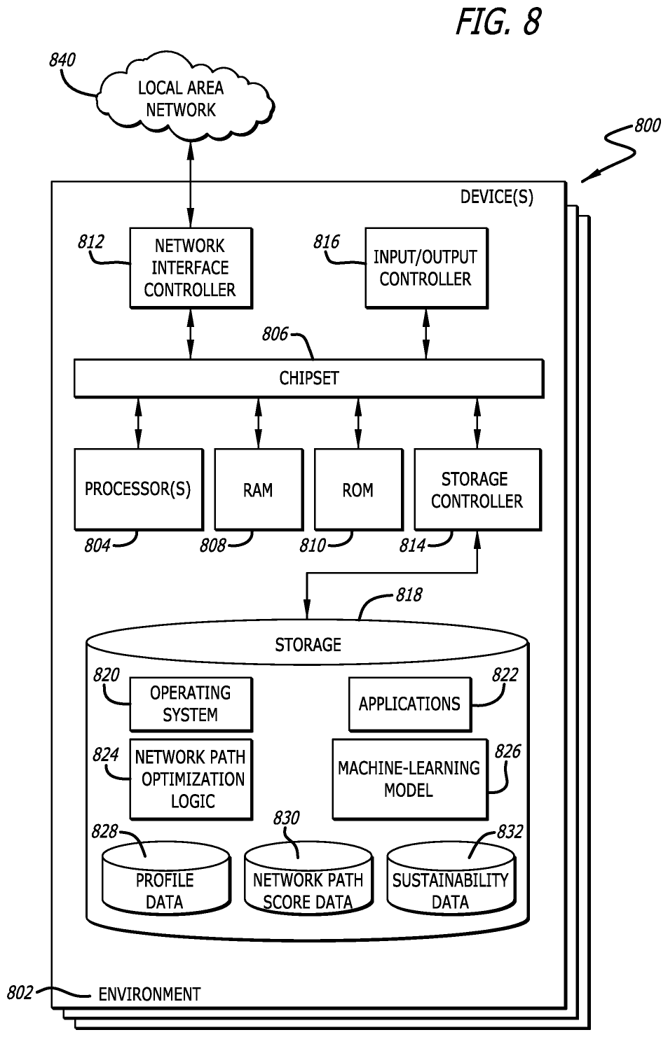

Referring to FIG. 8, a conceptual block diagram of a device suitable for determining and powering down redundant network paths within a network is shown. The embodiment of the conceptual block diagram depicted in FIG. 8 can illustrate an access point, conventional server computer, workstation, desktop computer, laptop, tablet, network appliance, e-reader, smartphone, or other computing device, and can be utilized to execute any of the application and/or logic components presented herein. The device 800 may, in some examples, correspond to physical devices or to virtual resources described herein. In more embodiments, the device 800 may be part of a system such as, but not limited to, an ecosystem management tool.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In additional embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for example, store an operating system 820, applications 822, and data, which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more computer devices 800 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In various embodiment, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In more embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8, and can include other components that are not explicitly shown in FIG. 8, or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In many embodiments, the device 800 can include a network path optimization logic 824. The network path optimization logic 824 can be configured to execute the various steps, methods, and/or processes described herein. In some embodiments, the network path optimization logic 824 can determine an availability profile and power expenditure metric for each network path and associated components. In further embodiments, the network path optimization logic 824 can utilized the determined availability profiles and power expenditure metrics to generate a sustainable network path score which may be utilized to categorize various network paths between two devices within a managed network.

In more embodiments, the network path optimization logic 824 can compare the sustainable network path scores against a predetermined threshold in order to select one or more network paths for redundancy. Based on this selection, the network path optimization logic 824 may initiate a power down command to these path components, or at least send a request to enter a lower power mode. In additional embodiments, the network path optimization logic 824 can monitor for various changes in the network that may necessitate a reassessment of the various network states such that a new sustainable network path score can be generated and utilized to classify various network paths as redundant or not.

In a number of embodiments, the storage 818 can include profile data 828. Profile data 828 may include various data related to the determined pairs of devices within the managed network, and their associated network paths and components. The profile data 828 may further be configured to include various known SLA settings related to client applications that may be utilizing the network for data transport. In some embodiments, the profile data 828 can include a network topology that can be generated by and/or utilized by an ecosystem management tool for managing the network. Similarly, profile data 828 may include network administration preferences that can indicate the threshold to compare sustainable network path scores to. In this way, the amount of energy savings (i.e., the aggressiveness) within the network can be determined.

In various embodiments, the storage 818 can include network path score data 830. Often, the network path score data 830 comprises sustainable network path scores. As described above, these scores may be generated for each pair of edge devices within the network under management. If not, changes are present between the edge devices, then the network path score data 830 does not need to be changed for that pair when reassessing the future. However, network path score data 830 can be updated or utilized to trigger a new assessment on network path redundancy. As network sizes grow, the network path score data 830 may increase greatly to accommodate all potential pairs of network devices.

In still more embodiments, the storage 818 can include sustainability data 832. As described above in the discussion of FIG. 1, sustainability attribute data can include sustainability attributes of various devices, elements, and other components of a network and associated network paths/components. The sustainability data 832 may comprise both capability data related to various devices but can also include the power source type associated with each device within a network proposed or being utilized by for data transfer. In some embodiments, the sustainability data 832 can include historical data such that decisions or inferences can be generated without all current real-time data, or to make a prediction of upcoming network conditions.

Finally, in many embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826. The ML model 826 may be configured to determine various profiles, metrics and/or scores, such as a sustainable network path score. In additional embodiments, the ML model 826 may be utilized to determine one or more redundant network paths and/or transport subsystems.

Although specific embodiments are described above with respect to FIG. 8, any of a variety of systems and/or processes may be utilized in accordance with embodiments of the disclosure. For example, device may be executed as part of a cloud-based ecosystem management tool that is operated by a network administrator. The aspects described in FIG. 8 may also be interchangeable with other elements of FIGS. 1-7 as required to realize a particularly desired embodiment.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public, regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a network path optimization logic that is configured to:
identify network path options between two devices within the network, wherein the network comprises a plurality of transport subsystems;
determine an availability profile for each network path option;
determine a power expenditure metric for each of the plurality of transport subsystems;
generate a sustainable network path score based on the availability profile and the power expenditure metric;
select a network path based on the generated sustainable network path score; and
power off the selected network path.

2. The device of claim 1, wherein the network path options are identified within a set of devices.

3. The device of claim 2, wherein the set of devices is within a managed network domain.

4. The device of claim 1, wherein the device is in communication with a plurality of client applications.

5. The device of claim 4, wherein the plurality of client applications has an associated service level agreement (SLA).

6. The device of claim 5, wherein the availability profile is determined based on the client application SLAs.

7. The device of claim 6, wherein the availability profile is determined based on the SLA with the highest level of availability.

8. The device of claim 1, wherein the power expenditure metric is determined based on an expected bandwidth usage.

9. The device of claim 8, wherein the power expenditure metric is determined based on all available bandwidth including currently powered down transport subsystems.

10. The device of claim 1, wherein the network comprises a plurality of point-to-point paths.

11. The device of claim 10 wherein the sustainable network path scores are generated for each of the plurality of point-to-point paths.

12. The device of claim 11, wherein the generated sustainable network path scores for each point-to-point path are stored upon generation.

13. The device of claim 1, wherein the network path optimization logic can be configured to generate a new sustainable network path score in response to a predefined event.

14. The device of claim 13, wherein the predefined event is detecting a change in the identified network path options.

15. The device of claim 13, wherein the predefined event is a network failure detection.

16. The device of claim 13, wherein the predefined event is a service level agreement (SLA) change detection.

17. A method of reducing redundant network paths, comprising:
identifying network path options between two devices within a network, wherein the network comprises a plurality of transport subsystems;
determining an availability profile for each network path option;
determining a power expenditure metric for each of the plurality of transport subsystems;
generating a sustainable network path score based on the availability profile and power expenditure metric;
selecting a network path based on the generated sustainable network path score; and
powering off the selected network path.

18. The method of claim 17, wherein powering off of a selected network path does not violate a service level agreement (SLA).

19. The method of claim 17, wherein the method further powers on a selected network path based on the generated sustainable network path score to avoid a violation of a service level agreement (SLA).

20. A device, comprising:
a processor;
at least one network interface controller (NIC), wherein the NIC provides access to a plurality of client devices within a network; and
a memory communicatively coupled to the processor, wherein the memory comprises a network path optimization logic that is configured to:
establish a connection with one or more client applications associated with the plurality of client devices, wherein the one or more client applications are each associated with a service level agreement (SLA);
identify network path options between two devices within the network, wherein the network comprises a plurality of transport subsystems;
determine an availability profile for each network path option based on the SLAs;
determine a power expenditure metric for each of the plurality of transport subsystems;
generate a sustainable network path score based on the availability profile and power expenditure metric;
select a network path based on the generated sustainable network path score;
adjust the energy usage of the selected network path;
detect a change in an associated SLA;
determine a new availability profile based on the changed SLA;
generate an updated sustainable network path score based on the new availability profile;
select an updated network path based on the updated sustainable network path score; and
re-adjust the energy usage of the selected network path.
